(19) United States
(12) Patent Application Publication
(10) Pub. No.: US 2024/0302174 A1
(43) Pub. Date: Sep. 12, 2024

(54) ROUTE PLANNING DEVICE, ROUTE PLANNING METHOD, AND PROGRAM

(71) Applicant: SONY GROUP CORPORATION, TOKYO (JP)

(72) Inventor: DAISUKE FUKUNAGA, TOKYO (JP)

(21) Appl. No.: 18/551,631

(22) PCT Filed: Jan. 14, 2022
(86) PCT No.: PCT/JP2022/001211

§ 371 Date: Sep. 21, 2023

(30) Foreign Application Priority Data
Apr. 5, 2021 (JP) 2021-064450

(51) Int. Cl. G01C 21/34

(52) U.S. Cl. CPC G01C 21/3415

(57) ABSTRACT

A route planning device according to the present disclosure includes: a position prediction section that predicts positions of a plurality of mobile bodies to be obtained after a lapse of a predetermined period of time, the plurality of mobile bodies moving in accordance with a first route plan; and a route planning section that replans routes of the plurality of mobile bodies on the basis of a result of a prediction made by the prediction section, generates a second route plan, and outputs movement instructions to the respective plurality of mobile bodies based on the second route plan, during a period when at least one of the plurality of mobile bodies is moving in accordance with the first route plan.

### TECHNICAL FIELD

The present disclosure relates to a route planning device, a route planning method, and a program that plan movement routes of a plurality of mobile bodies.

### BACKGROUND ART

There have been technologies of planning routes for a plurality of mobile bodies (such as robots) (see PTLs 1 to 3 and NPL 1).

### CITATION LIST

### Patent Literature

PTL 1: Japanese Unexamined Patent Application Publication No. 2020-149370
PTL 2: Japanese Unexamined Patent Application Publication No. 2004-280213
PTL 3: Japanese Unexamined Patent Application Publication No. 2009-20773

### Non-Patent Literature

NPL 1: G. Sharon, et al., “Conflict-Based Search for Optimal Multi-Agent Pathfinding,” Artificial Intelligence, Vol. 219, pp. 40-66 (2015)

### SUMMARY OF THE INVENTION

There have been requests to change route plans for the plurality of mobile bodies that are moving in accordance with the route plans, later.

It is desirable to provide a route planning device that makes it possible to efficiently replan routes of a plurality of mobile bodies, a route planning method, and a program.

A route planning device according to an embodiment of the present disclosure includes: a position prediction section, and a route planning section. The position prediction section predicts positions of a plurality of mobile bodies to be obtained after a lapse of a predetermined period of time, the plurality of mobile bodies moving in accordance with a first route plan. The route planning section replans routes of the plurality of mobile bodies on the basis of a result of a prediction made by the prediction section, generates a second route plan, and outputs movement instructions to the respective plurality of mobile bodies based on the second route plan, during a period when at least one of the plurality of mobile bodies is moving in accordance with the first route plan.

A route planning method according to an embodiment of the present disclosure includes: predicting positions of a plurality of mobile bodies to be obtained after a lapse of a predetermined period of time, the plurality of mobile bodies moving in accordance with a first route plan; and replanning routes of the plurality of mobile bodies on the basis of a result of the predicting, generating a second route plan, and outputting movement instructions to the respective plurality of mobile bodies based on the second route plan, during a period when at least one of the plurality of mobile bodies is moving in accordance with the first route plan.

A program according to an embodiment of the present disclosure causes a computer to perform a process including: predicting positions of a plurality of mobile bodies to be obtained after a lapse of a predetermined period of time, the plurality of mobile bodies moving in accordance with a first route plan; and replanning routes of the plurality of mobile bodies on the basis of a result of the predicting, generating a second route plan, and outputting movement instructions to the respective plurality of mobile bodies based on the second route plan, during a period when at least one of the plurality of mobile bodies is moving in accordance with the first route plan.

A route planning device, a route planning method, or a program according to an embodiment of the present disclosure predicts positions of a plurality of mobile bodies to be obtained after a lapse of a predetermined period of time, the plurality of mobile bodies moving in accordance with a first route plan, replans routes of the plurality of mobile bodies on the basis of a result of prediction, and generates a second route plan during a period when at least one of the plurality of mobile bodies is moving in accordance with the first route plan.

### BRIEF DESCRIPTION OF THE DRAWINGS

FIG. 1 is an explanatory diagram schematically illustrating a first example of a route planning method according to a technology related to a comparative example.

FIG. 2 is an explanatory diagram schematically illustrating a second example of a route planning method according to the technology related to the comparative example.

FIG. 3 is an explanatory diagram schematically illustrating an issue that a route replanning method according to the technology related to the comparative example has.

FIG. 4 is a block diagram schematically illustrating a configuration example of a route planning device according to a first embodiment of the present disclosure.

FIG. 5 is a flowchart illustrating an example of a replanning procedure performed by the route planning device according to the first embodiment.

FIG. 6 is a flowchart illustrating a detailed example of a stop instruction process in Step S13 in FIG. 5.

FIG. 7 is a flowchart illustrating a detailed example of a movement instruction process in Step S15 in FIG. 5.

FIG. 8 is an explanatory diagram schematically illustrating an example of interference between routes of a plurality of robots.

FIG. 9 is an explanatory diagram schematically illustrating a display example of an initial state of a user interface screen of a display section of the route planning device according to the first embodiment.

FIG. 10 is an explanatory diagram schematically illustrating a screen display example of the user interface screen illustrated in FIG. 9 while replanning routes.

FIG. 11 is an explanatory diagram schematically illustrating a screen display example of the user interface screen illustrated in FIG. 9 after the route replanning is completed.

FIG. 12 is a block diagram schematically illustrating an example of a system to which the route planning device according to the first embodiment is applied.

### MODES FOR CARRYING OUT THE INVENTION

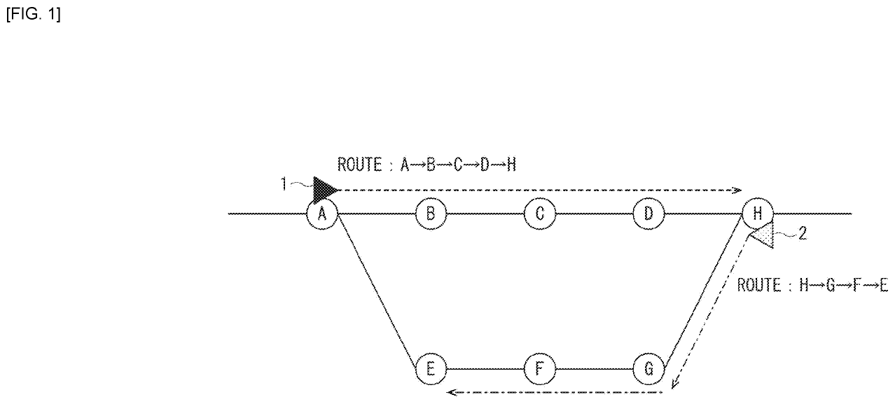

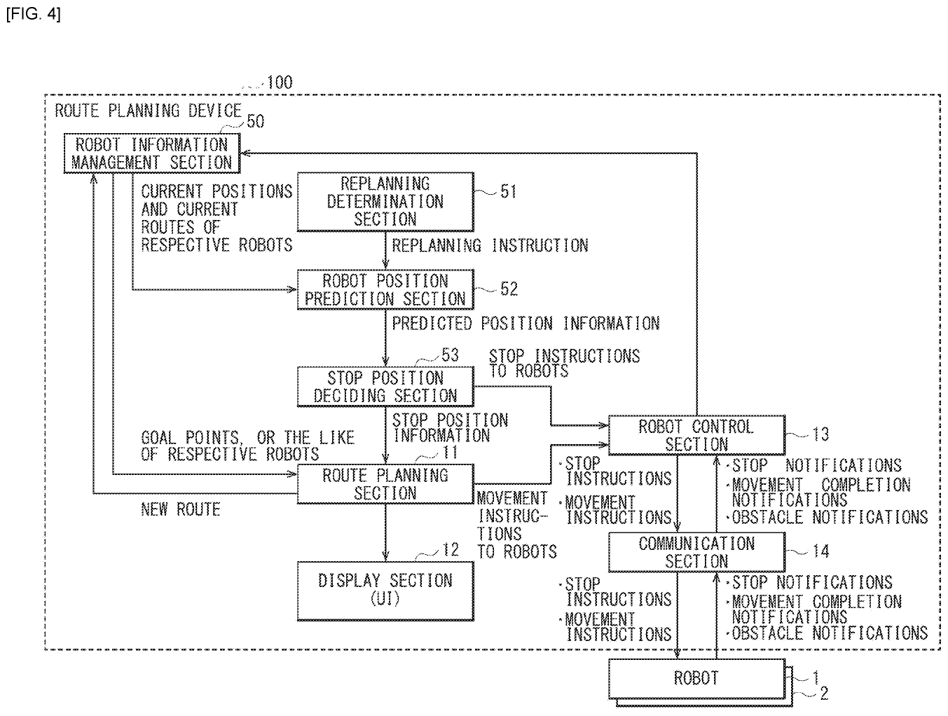

Next, with reference to drawings, details of embodiments of the present disclosure is described. It is to be noted that the description is given in the following order.
0. Comparative example (FIG. 1 to FIG. 3)
1. First Embodiment (FIG. 4 to FIG. 12)
1.0 Overview
1.1. Configuration
1.2 Operation
1.3 Application Example
1.4 Effects
2. Other Embodiments

### 0. Comparative Example

### (Overview of Route Planning Method According to Technology Related to Comparative Example)

Route planning is one of major functions of an autonomous mobile robot. The route planning is to calculate which routes the robot should take to move to a goal point by using a map of an ambient environment. In addition, multiple robot route planning is to calculate routes of a plurality of robots at the same time. In the case of the multiple robot route planning, it is necessary to search for routes that do not conflict with other robots. Therefore, the multiple robot route planning needs a more complicated calculation than single robot route planning. The wording “conflict” means a state where robots are not able to arrive at their goals due to a deadlock, a collision, or the like between the robots.

FIG. 1 schematically illustrates a first example of a route planning method according to a technology related to a comparative example.

The multiple robot route planning is mostly applied to a graph structure as in FIG. 1. The graph illustrates an environment where robots move as the graph structure. For example, output of a route plan is illustrated by using a sequence of vertices that a robot passes through. FIG. 1 illustrates an example of route plans of two robots 1 and 2 in a graph structure having vertices A, B, C, D, E, F, G, and H. In FIG. 1, the route plan of the robot 1 is outputted as a plan to pass through a vertex A, a vertex B, a vertex C, a vertex D, and a vertex H in this order, for example.

The multiple robot route planning sometimes uses a graph search algorithm such as A* or conflict-based search (CBS) (see NPL1) to search for routes that do not cause conflict among robots. The graph search algorithm is a complicated process and takes time. In some cases it takes seconds to tens of seconds to find a solution if the number of robots increases or if searching for a more optimal plan. Here, in general, the optimal plan means a set of routes that provide minimal time for the robots to arrive at their goals. The more optimal plan means a solution that provides shorter time for the robots to arrive at their goals.

After the route planning, there is a phase of actually moving the robots in accordance with the found routes. Ways of moving the robots include a method of controlling an order of arrival at vertices (see PTL1, for example). The method converts a route plan output that is generally represented by vertex passing time into the order of arrival at vertices and controls the robots in such a manner that the robots move in this order.

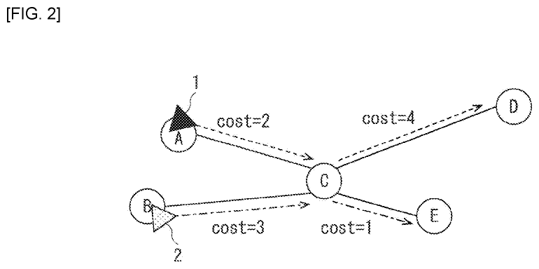

FIG. 2 schematically illustrates a second example of a route planning method according to the technology related to the comparative example.

It is assumed that a route plan for the two robots 1 and 2 is made with regard to the graph structure illustrated in FIG. 2 and the plan is outputted as described below. In general, the route plan output has the following form.
Robot 1: move from a vertex A to a vertex C [0, 2]→move from the vertex C to a vertex D [2, 6]
Robot 2: wait at a vertex B [0, 2]→move from the vertex B to the vertex C [2, 5]→move from the vertex C to a vertex E [5, 6]

The respective numbers in the brackets [ ] represent movement/standby start time and movement/standby end time. For example, “move from the vertex A to the vertex C [0, 2]” means that the robot moves from the vertex A to the vertex C in a time period from time t=0 to time t=2. Here, time it takes to move is referred to as a cost. In the example illustrated in FIG. 2, a cost for the robot 1 to move from the vertex A to the vertex C is 2.

According to this plan, the two robots pass through the vertex C. In addition, the two robots need to pass through the vertex C in order of the robot 1 and the robot 2. However, as long as the robots pass through the vertex C in order of the robot 1 and the robot 2, it is possible to carry the plan with no conflict between the robots 1 and 2. Accordingly, it is sufficient to control the robots 1 and 2 in such a manner that the vertex passing (arrival) order is maintained. Such a method has an advantage that the plan does not collapse even if the robot 1 or 2 does not move on time as planned due to a certain reason. For example, even if the first movement of the robot 1 (movement from vertex A to vertex C) is delayed until time t=4 due to an obstacle that has appeared suddenly, the robot 2 is controlled in such a manner that the robot 2 waits at the vertex B until the robot 1 passes through the vertex C. This can prevent the plan from collapsing. If controlling the robot B in such a manner that the robot 2 waits at the vertex B until the time t=2 and then starts moving to the vertex C, there is a possibility that the robot 2 may arrive at the vertex C before the robot 1 arrives at the vertex C, and this may collapse the plan.

### (Overview of Route Replanning Method According to Technology Related to Comparative Example)

Next, route replanning is described. The route replanning is to change an already-planned route of a robot later. For example, a route is planned, a movement instruction is outputted to a robot, but another route is planned while the robot is moving toward a goal point, and the movement instruction to the robot is also changed. In a case where routes are planned by using a global optimization algorithm that optimizes entire routes of the plurality of robots (algorithm that minimizes a sum of goal arrival time of all robots), there is a possibility that the routes of all the robots (robots whose goals have already been set) may change when a new goal is added (with regard to one certain robot). In other words, route replanning is performed at this time. In addition, the route replanning is also performed when the graph structure is changed due to a dynamic obstacle or when progress of movement of the robots is deviating from the plan. The technology according to the present disclosure is a method related to the route replanning. (Issue That Route Replanning Method According to Comparative Example Has) In general, route replanning is performed in accordance with a flow of procedures A-1 to A-4 listed below.
(Procedure A-1) Fire a trigger of replanning
(Procedure A-2) Search for routes
(Procedure A-3) Abandon current movement instructions
(Procedure A-4) Issue new movement instructions to robots on the basis of found routes

Here, when replanning the route, there is a delay between start of the replanning and issue of a replanned movement instruction to the robot. The delay is caused by time it takes to search for the route (as described above, there is a case where it takes seconds to tens of seconds) or communication time for issuing the movement instruction to the robot. The delay may cause an issue in movement of a plurality of robots. Examples of the issue include an issue that robots collide with each other and further an issue that a deadlock related to movement occurs and the robots are not able to arrive at their goals.

Next, three replanning methods considered as technologies related to the comparative example and issues that these methods have are described.

### (Method 1) Method of Performing Replanning Regardless of Delay

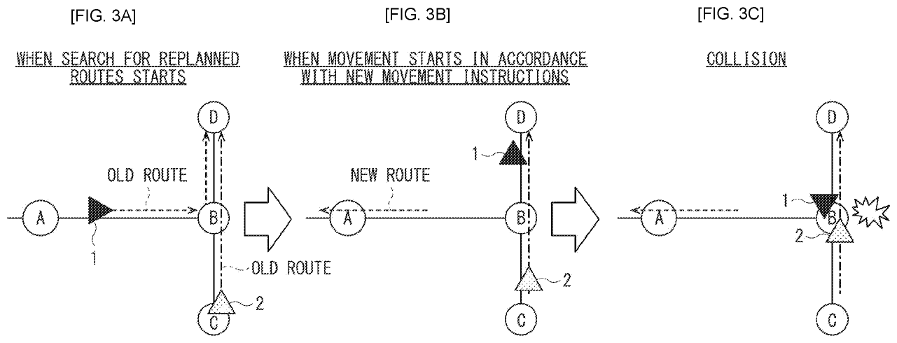

This is a method of performing replanning while ignoring the above-described delay. In this case, a route search start point is a position of a robot obtained when replanning starts (Procedure A-1). However, the robot moves in accordance with an original movement plan during search for a route. Therefore, sometimes a position of the robot obtained when a new movement instruction is issued to the robot (Procedure A-4) is different from the start point of the search for a route. This may cause an issue such as a deadlock or a collision between the robots. FIG. 3 illustrates an example of a case of the collision.

FIG. 3 schematically illustrates an issue that the route replanning method according to the technology related to the comparative example has.

First, a search for a route of the robot 1 and a route for the robot 2 is performed while their start points are set to positions obtained when a search for replanned routes starts ((A) in FIG. 3, Procedure A-1). The robots 1 and 2 are following their old routes when new movement instructions are issued after the route search (when movement starts in accordance with the new movement instructions, (B) in FIG. 3, Procedure A-4). Therefore, the robot 1 first turns back to return to the start point obtained when the search for replanned routes starts. However, the robot 1 collides with the robot 2 that is moving in accordance with the movement instruction based on a new route plan. ((C) in FIG. 3). The routes found by replanning ensure that there is no collision or deadlock from the start points to the goal points. However, the movement of the robot 1 from a current location to the start point as illustrated in (B) and (C) of FIG. 3 is movement along the route that is not included in a search result, and such movement does not ensure that there is no collision or deadlock. Therefore, this causes the issue illustrated in (C) of FIG. 3.

### (Method 2) Method of Stopping Movement of All Robots at Time of Replanning

It is possible to prevent the issue arising from Method 1 by stopping movement of all the robots before searching for routes after the trigger of route replanning is fired (between Procedure A-1 and Procedure A-2). This makes positions of the robots obtained when the new movement instructions are issued (Procedure A-4) become the same as the route search start points. Replanning procedures in the case of this method include procedures A-1′ to A-5′ listed below.
(Procedure A-1′) Fire a trigger of replanning
(Procedure A-2′) Stop movement of all robots
(Procedure A-3′) Search for routes while start points are set to locations where robots have stopped
(Procedure A-4′) Abandon current movement instructions
(Procedure A-5′) Issue new movement instructions to robots on the basis of the found routes

This method does not cause the issue such as a deadlock or a collision (issue that that robots are not able to normally arrive at their goals). However, this method has other issues such as deterioration in movement efficiency or waste of electric power. When stopping the robots, loss of time is caused because the robots are not able to stop suddenly (it is necessary to brake and gradually slow down). In addition, in a case where the robots start moving after a temporary stop, the robots consume more electric power than in a case where the robots move without stopping. When using the route planning based on the global optimization algorithm, frequency of replanning is increased as the number of robots gets larger. Therefore, wasted time and electricity increase if the movement of the robots is stopped each time.

### (Method 3) Method of Predicting Future Positions of Robots And Planning Their Routes While The Start Points Are Set to The Predicted Positions

Last of all, a method of predicting future positions of robots and setting their route search start points to the predicted positions is considered. According to the method, the route search start points become the same as positions of robots obtained when issuing new movement instructions if prediction is precise. Therefore, the issue such as a collision or a deadlock does not arise and it is possible to replan routes without stopping the robots. However, in the same manner as Method 1, sometimes the issue such as a collision or a deadlock may arise if prediction fails. It is highly likely that prediction fails. Therefore, this method also includes some issues. For example, sometimes movement of robots take more time than predicted because of external factors such as the dynamic obstacle. In addition, one of factors in the failed prediction is that it is difficult to accurately estimate time it takes to search for route by using the algorithm (Procedure A-2).

As described above, the above-described first to third replanning methods each have issues. Therefore, it is desired to develop technologies that make it possible to replan routes without stopping movement of robots as much as possible and without a collision or a deadlock between the robots.

### 1. First Embodiment

Next, an example in which mobile bodies are robots is described. However, the technology according to the present disclosure is applicable to mobile bodies other than the robots.

### [1.0 Overview]

The technology according to the present disclosure is a novel method that does not stop movement of a plurality of robots as much as possible and does not cause a collision or a deadlock between the plurality of robots, when replanning a route plan of the plurality of robots. Procedures B-1 to B-4 of a route planning method according to the technology of the present disclosure is listed below.

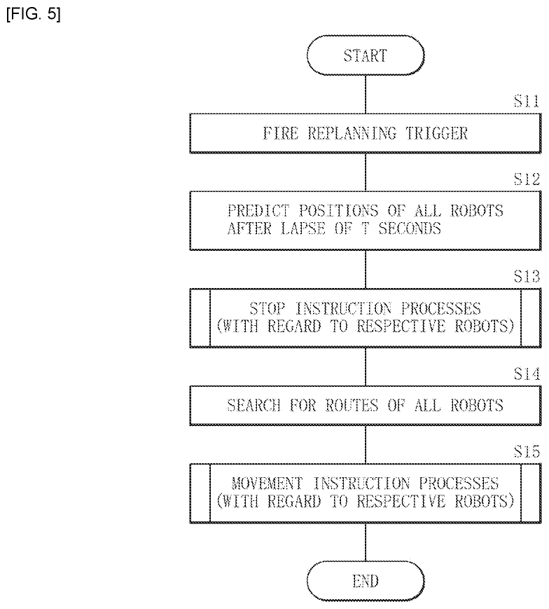

(Procedure B-1) Predict positions of a plurality of robots to be obtained after a lapse of a predetermined period of time (after T seconds), the plurality of robots moving in accordance with an old route plan (first route plan) that has been obtained before replanning. The procedure B-1 corresponds to Step S12 illustrated in FIG. 5 (to be described later).
T seconds is decided on the basis of time it takes to search for routes or delay time before issuing instructions to the respective robots. Respective positions of moving robots are predicted in view of current positions, speeds of respective robots, rendezvous time among the plurality of robots, and the like. With regard to a robot to which the movement instruction is not issued, its current position is treated as a predicted position.

(Procedure B-2) Decide stop instruction positions of the respective robots in such a manner that the robots stop near the respective positions predicted in the procedure B-1, and issue stop instructions to the respective robots. The procedure B-2 corresponds to a stop instruction process in Step S13 illustrated in FIG. 5 (to be described later).

However, the stop instruction is not issued to a robot that is not moving after T seconds. The robot that is not moving is a robot to which the movement instruction has not been issued in the first place, or a robot to which the movement instruction has been issued but whose movement is completed after T seconds. Before arriving at a stop instruction position instructed through the stop instruction, sometimes a robot temporarily stops due to another rendezvous (based on old route plan). In other words, an algorithm is performed in such a manner that the old route plan (including rendezvous) is sustained but the plan is temporarily stopped at a certain point of time. It is to be noted that a way to decide the stop instruction positions based on the stop instructions is described later.

(Procedure B-3) Search for routes of all the robots while their start points are set to the stop instruction positions at which the robots are instructed to stop in the procedure B-2. The procedure B-3 corresponds to a process in Step S14 illustrated in FIG. 5 (to be described later). The route search is performed during a period when at least one of the plurality of robots is moving in accordance with its old route plan.

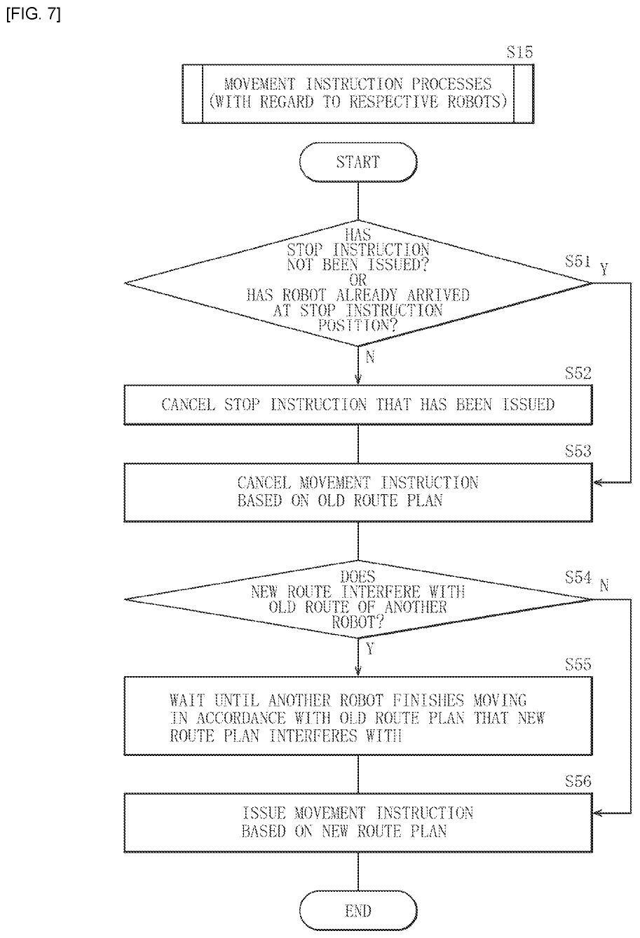

(Procedure B-4) When each robot arrives at its stop instruction position at which the robot is instructed to stop in the procedure B-2, abandon the old movement instruction (Step S53 in FIG. 7 (to be described later)), and issue a movement instruction to each robot on the basis of a new route plan (Step S56 in FIG. 7 (to be described later)). The procedure B-4 corresponds to a movement instruction process in Step S15 illustrated in FIG. 5 (to be described later).

In the case where the robot has arrived (stopped) at their stop instruction position at which the robot has been instructed to stop in the procedure B-2 (Y in Step S51 in FIG. 7 (to be described later)) when the route search finishes, the old movement instruction is abandoned immediately (Step S53 in FIG. 7 (to be described later)), and a new movement instruction is issued. In the case where the robot has not arrived at its stop instruction position at which the robot has been instructed to stop in the procedure B-2 (N in Step S51 in FIG. 7 (to be described later)), the stop instruction is canceled (Step S52 in FIG. 7 (to be described later)). And then, (the old movement instruction is abandoned and) a new movement instruction is issued immediately after the robot arrives at the stop instruction position. In this case, the robot makes it possible to perform replanning without stopping. However, the robot does not move immediately in the case where its new route plan interferes with an old route plan of another robot (Y in Step S54 in FIG. 7 (to be described later)). One reason for this is to prevent a collision or a deadlock (to be described later).

A feature of the technology according to the present disclosure is to prevent a collision or a deadlock by “issuing a stop instruction to a robot to stop at a predicted position (or slightly beyond the predicted position)” and “considering a dependent relationship between an old route plan and a new route plan” even if position prediction fails.

By issuing a stop instruction to each robot to stop at its predicted position (or slightly beyond the predicted position), all the robots move in accordance with the old route plan until arriving at their stop instruction positions. This makes it possible to cause no collision or deadlock. In addition, the new route plan starts at the stop instruction positions, and the new route plan (movement) starts in view of the dependent relationship between the old route plan and the new route plan. Therefore, this makes it possible to cause no collision or deadlock even if the robots move in accordance with the new route plan.

If the position of the respective robots is predicted correctly, the route search finishes immediately before the robots stop. Therefore, it is possible to cancel the stop instructions before the respective robots stop, and it is possible to directly transition to the new route plan after the robots arrive at their stop instruction positions. In other words, it is possible to move along the replanned routes without stopping the respective robots.

### [1.1. Configuration]

FIG. 4 schematically illustrates a configuration example of a route planning device 100 according to a first embodiment of the present disclosure for achieving the above-described route planning method according to the technology of the present disclosure.

The route planning device 100 includes a route planning section 11, a display section 12, a robot control section 13, a communication section 14, a robot information management section 50, a replanning determination section 51, a robot position prediction section 52, and a stop position deciding section 53.

It is to be noted that FIG. 4 only illustrates the two robots 1 and 2 as the plurality of robots for the sake of simplification of description. However, the device may be configured to include three or more robots.

The route planning device 100 according to the first embodiment may be implemented by a computer terminal including a central processing unit (CPU), a read only memory (ROM), and a random access memory (RAM), for example. In this case, processes may be implemented by the route planning section 11, the robot control section 13, the robot information management section 50, the replanning determination section 51, the robot position prediction section 52, and the stop position deciding section 53 when the CPU performs processes based on programs stored in the ROM or the RAM. In addition, a process may be implemented by the route planning device 100 when the CPU performs a process based on a program provided, for example, from the outside via a wired or wireless network.

The replanning determination section 51 issues a replanning instruction on the basis of a replanning trigger. The replanning trigger includes addition of a new destination, detection of a dynamic obstacle, detection of a difference between the plan and progress of movement, and the like. The replanning trigger may be inputted from a higher level system. The robots 1 and 2 may include a sensor that detects the dynamic obstacle. The robot 1 or 2 may notify the route planning device 100 of detection of the dynamic obstacle as an obstacle notification.

The robot position prediction section 52 is a position prediction section that predicts positions of the robots 1 and 2 moving in accordance with the old route plan (first route plan), on the basis of the replanning instructions from the replanning determination section 51. When receiving the replanning instructions, the robot position prediction section 52 first predicts positions of the robots 1 and 2 to be obtained after T seconds. T may be a preset time interval, or may be a time interval that dynamically changes in response to feedback such as route search time or delay of instructions to the robot 1 or 2 during system operation. When predicting the positions of the robots 1 and 2, the robot position prediction section 52 receives information such as current positions or current routes of the robots 1 and 2 from the robot information management section 50.

The stop position deciding section 53 decides positions of stopping the robots 1 and 2 (stop instruction positions) on the basis of predicted position information from the robot position prediction section 52. The stop position deciding section 53 outputs stop instructions to the robot control section 13 based on the decided stop instruction positions. In addition, the stop position deciding section 53 also outputs stop position information to the route planning section 11.

During a period when at least one of the robots 1 and 2 is moving in accordance with the old route plan, the route planning section 11 replans routes of the robots 1 and 2, generates a new route plan (second route plan), and outputs movement instructions to the respective robots 1 and 2 based on the new route plan. The route planning section 11 generates the new route plan by searching for routes while the start points are set to the stop instruction positions of the robots 1 and 2 based on the stop position information from the stop position deciding section 53. When searching for routes, the route planning section 11 receives information such as goal points or the like of the robots 1 and 2 from the robot information management section 50. The route planning section 11 outputs the movement instructions related to the robots 1 and 2 to the robot control section 13 on the basis of results of the route search. In addition, the route planning section 11 outputs information related to new routes to the robot information management section 50.

Via the communication section 14, the robot control section 13 outputs the stop instructions from the stop position deciding section 53 to the robots 1 and 2 and outputs the movement instructions from the route planning section 11 to the robots 1 and 2. In addition, the robot control section 13 outputs stop notifications, movement completion notifications, and obstacle notifications that have been received from the robots 1 and 2 via the communication section 14, to the robot information management section 50.

The robot control section 13 cancels a stop instruction to a robot that has not arrived at the stop instruction position and then outputs a movement instruction based on the new route plan, in the case where the robots 1 and 2 include the robot that has not arrived at the stop instruction position when the route planning section 11 finishes searching for the routes.

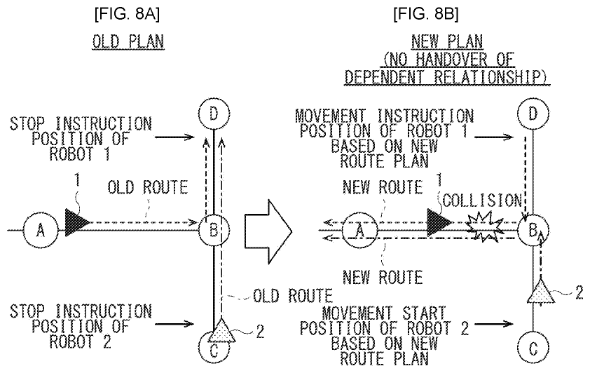

In addition, as illustrated in FIG. 8 (to be described later), the robot control section 13 outputs a movement instruction to a robot (such as the robot 2) serving as a second mobile body in view of interference between a route of a robot (such as the robot 1) serving as a first mobile body based on the old route plan and a route of the robot (such as the robot 2) serving as the second mobile body based on the new route plan.

In the case where interference occurs between the route of the robot serving as the first mobile body based on the old route plan and the route of the robot serving as the second mobile body based on the new route plan, the robot control section 13 outputs a movement instruction to the robot serving as the second mobile body based on the new route plan after the robot serving as the first mobile body finishes moving based on the old route plan. Alternatively, in the case where interference occurs between the route of the robot serving as the first mobile body based on the old route plan and the route of the robot serving as the second mobile body based on the second route plan, the robot control section 13 may temporarily stop movement of the robot serving as the second mobile body based on the second route plan before a position where the interference occurs. Next, the robot control section 13 may restart the movement of the robot serving as the second mobile body after the robot serving as the first mobile body completes moving to the position where the interference occurs.

The robot information management section 50 manages various kinds of information necessary to route planning. The robot information management section 50 stores information related to new routes received from the route planning section 11. In addition, the robot information management section 50 stores information related to current positions and the like of the robots 1 and 2 on the basis of the stop notifications and the movement completion notifications that have been received from the robots 1 and 2 via the communication section 13.

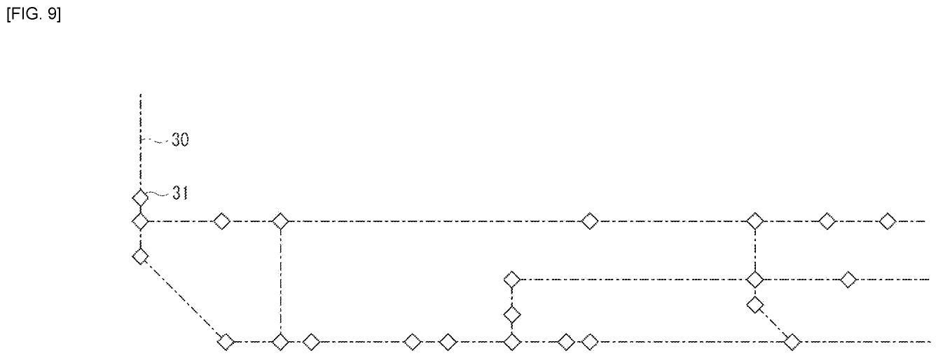

The display section 12 includes a display, for example, and displays information such as routes or the like of the robots 1 and 2 planned by the route planning section 11. For example, the display section 12 displays a user interface (UI) screen as illustrated in FIG. 9 to FIG. 11 (to be described later). For example, the display section 12 displays a route of the old route plan in such a mode that a route before the stop instruction position is distinguishable from a route after the stop instruction position while the route planning section 11 is searching for a route. In addition, for example, after a new route plan is fixed, the display section 12 displays the stop instruction position and a route of the new route plan.

### [1.2 Operation]

FIG. 5 is a flowchart illustrating an example of a replanning procedure performed by the route planning device 100 according to the first embodiment.

First, the replanning determination section 51 outputs a replanning instruction on the basis of firing of a replanning trigger (Step S11). Next, the robot position prediction section 52 predicts positions of all robots to be obtained after a lapse of a predetermined period of time (after T seconds) (Step S12).

Next, the stop position deciding section 53 performs stop instruction processes on the respective robots (Step S13). Next, the route planning section 11 searches for routes of all the robots (Step S14). Next, the robot control section 13 performs movement instruction processes on the respective robots (Step S15), and ends the replanning process.

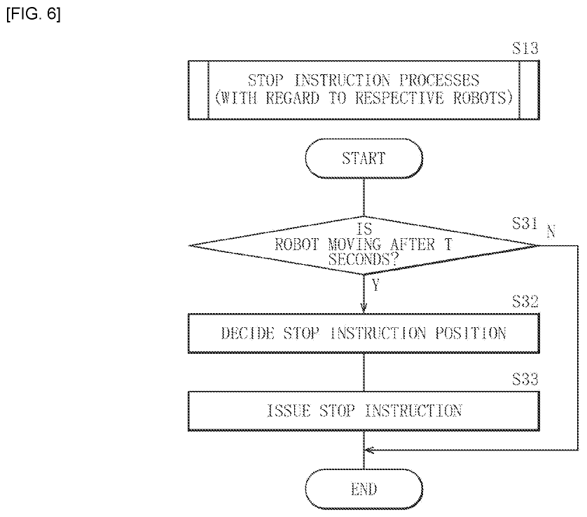

FIG. 6 is a flowchart illustrating a detailed example of the stop instruction process in Step S13 in FIG. 5.

First, the stop position deciding section 53 determines whether or not a certain robot is moving after T seconds (Step S31). In the case where it is determined that the robot is not moving after T seconds (N in Step S31), the stop position deciding section 53 ends the stop instruction process.

However, in the case where it is determined that the robot is moving after T seconds (Y in Step S31), the stop position deciding section 53 decides a stop instruction position subsequently (Step S32). Next, the stop position deciding section 53 issues a stop instruction (Step S33), and ends the stop instruction process.

FIG. 7 is a flowchart illustrating a detailed example of the movement instruction process in Step S15 in FIG. 5.

First, the robot control section 13 determines whether or not a stop instruction has been issued to a certain robot or whether or not the robot has already arrived at its stop instruction position (Step S51). In the case where it is determined that the stop instruction has not been issued to the certain robot or it is determined that the robot has already arrived at the stop instruction position (Y in Step S51), the robot control section 13 subsequently cancels the movement instruction based on the old route plan of the certain robot (Step S53). However, in the case where it is determined that the stop instruction has been issued to the certain robot or it is determined that the robot has not arrived at the stop instruction position yet (N in Step S51), the robot control section 13 subsequently cancels the stop instruction to the certain robot (Step S52), and cancels the movement instruction based on the old route plan of the certain robot (Step S53).

Next, the robot control section 13 determines whether or not a new route plan of the certain robot interferes with an old route plan of another robot (Step S54). In the case where it is determined that the new route plan of the certain robot does not interfere with the old route plan of the other robot (N in Step S54), the robot control section 13 subsequently issues a movement instruction based on the new route plan of the certain robot (Step S56) and ends the movement instruction process.

However, in the case where it is determined that the new route plan of the certain robot interferes with the old route plan of the other robot (Y in Step S54), the robot control section 13 subsequently waits until the other robot finishes moving in accordance with the old route plan that the new route plan interferes with (Step S55). Next, the robot control section 13 issues a movement instruction based on the new route plan to the certain robot (Step S56), and ends the movement instruction process.

### (Way to Decide Stop Instruction Position)

Next, a way to decide a position at which the stop instructions are issued to the respective robots in the above-described procedure B-2 is described. The stop instructions may be issued at positions predicted in the procedure B-1, or may be issued slightly beyond the predicted positions. When the stop instruction positions are set to positions that are slightly beyond the predicted positions, sometimes it may be possible for the respective robots to avoid stopping or slowing down (moratoriums before stop of respective robots are extended) even if a predicted position deviates from an actual position. In an environment where the respective robots move in the graph structure, it is also possible to issue the stop instruction at a vertex that comes next after a predicted position.
(Case where New Route Plan Interferes With Old Route Plan of Another Robot)
In the case where a new route plan of a certain robot interferes with an old route plan of another robot, that is, in the case where a route based on the new route plan of the certain robot overlaps a route based on the old route plan of the other robot, this may cause a collision or a deadlock among a plurality of robots unless new route planning starts in view of their dependent relationship (in view of the order of robots moving along interfering routes).

FIG. 8 schematically illustrates an example of interference between routes of a plurality of robots. In FIG. 8, (A) illustrates an example of an old route plan of the robots 1 and 2. In FIG. 8, (B) illustrates an example of a new route plan of the robots 1 and 2.

In the case illustrated in (B) in FIG. 8, the new route plan of the robot 2 interferes with the old route plan of the robot 1. As illustrated in (B) in FIG. 8, the robot 1 may collide with the robot 2 if the robot 2 starts moving in accordance with the new route plan before the robot 1 finishes moving to its stop instruction position (in accordance with the old route plan) in the state illustrated in (A) in FIG. 8.

It is possible to determine whether a new route plan of a certain robot interferes with an old route plan of another robot, by comparing their routes based on the new route plan with their routes based on the old route plan and determining whether or not one route has the same vertex or edge as another route. In the case where the new route plan of the certain robot interferes with the old route plan of the other robot, a dependent relationship is added to the new route plan by using any of two patterns listed below.

(Pattern 1) In the case where a new route plan of a certain robot (for example, robot 2) interferes with an old route plan of another robot (for example, robot 1), movement based on the new route plan starts after movement based on the interfering plan finishes.
(Pattern 2) In the case where a new route plan of a certain robot (for example, robot 2) interferes with an old route plan of another robot (for example, robot 1), positions of the interference in the plans are detected, movement based on the new route plan is temporarily stopped when the certain robot arrives at a position just before the position of the interference, and then the certain robot restarts moving in accordance with the new route plan immediately after the other robot completes its movement at the position of the interference in the old route plan.

In comparison with pattern 1, pattern 2 partially takes into consideration the dependent relationship, and this slightly improves movement efficiency. In the case of using pattern 2, the process of “waiting until the other robot finishes moving in accordance with the old route plan that the new route plan interferes with” in Step S55 in FIG. 7 is omitted, and it is possible to immediately issue a movement instruction based on a new route plan. However, the movement may be temporarily stopped and restarted appropriately in view of the dependent relationship with the old route plan.

### (Case Where Route Search Fails)

The route search (procedure B-3) fails in the case where it takes too much time to search for routes and timeout occurs, or in the case where there is no solution of the search. If the search fails, replanning is canceled by canceling all the stop instructions issued in the procedure B-2. If the replanning is canceled, the respective robots continue moving in accordance with the old route plan.

(Case Where Robot Is Not Able to Arrive at Stop Instruction Position Due to Dynamic Obstacle)

In the case where a certain robot is not able to arrive at its stop instruction position indicated in the procedure B-2 due to a dynamic obstacle, it is not possible to start movement based on a new route plan in the procedure B-4. In this case, the certain robot that is not able to arrive at its stop instruction position is detected in some way. If such a robot is detected, movement of the robot that is not able to arrive at its stop instruction position is stopped on the spot, and its route is replanned while the start point is set to the position where the robot has stopped. Methods of detecting that the robot is not able to arrive at its stop instruction position include the following patterns.
Each robot makes a detection by using information such as an ultrasonic sensor, and notifies of the route planning device.
Make a determination from change in an environmental map. Examples of the environmental map include a grid map and a topological map. It is to be noted that the change in the map is detected on the basis of sensor information from each robot.

Hereinafter, a flow of a process performed in the case where a robot is not able to arrive at a stop instruction position due to a dynamic obstacle is described.
(Step 1) Predict positions of respective robots to be obtained after T seconds.
(Step 2) Instruct the respective robots to stop near the positions predicted in Step 1.
(Step 3) Search for routes while their start points are set to the positions at which the robots are instructed to stop in Step 2.
(Step 4) Detect that a certain robot is not able to arrive at the position at which the robot is instructed to stop in Step 2, due to a dynamic obstacle. In the following steps, the detected robot is referred to as a robot A.
(Step 5) Stop the robot A on the spot.
(Step 6) Stop the replanning flow progressing up to Step 3. The stop instructions issued to the respective robots are canceled.
(Step 7) Predict positions of respective robots to be obtained after T seconds again. However, the position of the robot A is predicted to still be there after T seconds.
(Step 8) Instruct the respective robot to stop near the positions predicted in Step 7.
(Step 9) Search for routes while their start points are set to the positions at which the robots are instructed to stop in Step 8. At this time, the routes are planned in such a manner that the robots do not pass through a route blocked by the dynamic obstacle if the environmental map is updated to reflect the dynamic obstacle.
(Step 10) When each robot arrives at its position at which the robot is instructed to stop in Step 8, abandon the old movement instruction and issue a movement instruction to each robot on the basis of a new route plan.

### (User Interface)

Next, a user interface that uses characteristics of the technology of the present disclosure is described.

FIG. 9 schematically illustrates a display example of an initial state of a user interface screen of the display section 12 of the route planning device 100.

For example, the user interface screen displays passable routes (range of motion) 30 and stoppable points (points where robots are able to wait) 31 of a plurality of robots.

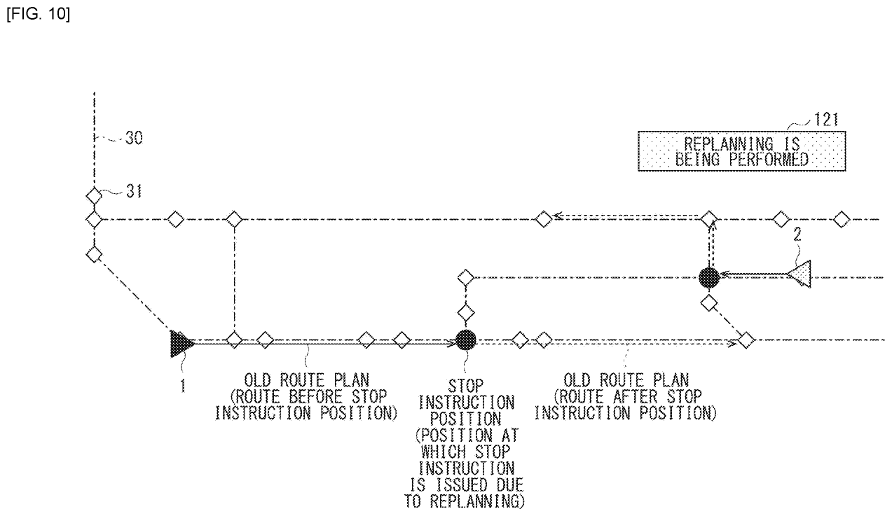

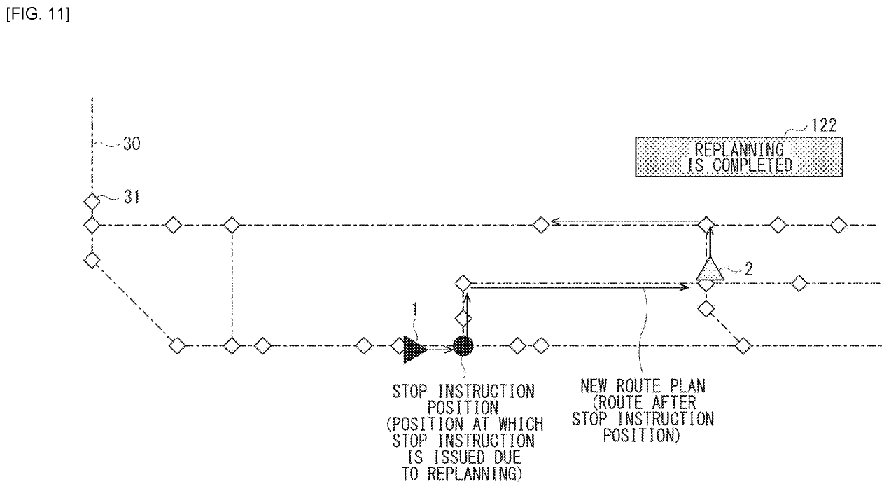

FIG. 10 schematically illustrates a screen display example of the user interface screen illustrated in FIG. 9 while replanning routes. FIG. 11 schematically illustrates a screen display example of the user interface screen illustrated in FIG. 9 after the route replanning is completed. FIG. 10 and FIG. 11 illustrate examples in which routes of the robots 1 and 2 serving as the plurality of robots are displayed.

One of the features of the route planning method according to the technology of the present disclosure is to predict positions of the plurality of robots at the time of replanning, issue stop instructions at (or near) the predicted positions, and search for new routes while their start points are set to the stop instruction positions. Therefore, at the time of replanning, the user interface screen may display “Old route plan (before stop instruction position)”, “Old route plan (after stop instruction position)”, “Stop instruction position”, or “New route plan (after stop instruction position)”. The “Old route plan (before stop instruction position)” means routes that the robots definitely pass through in future, whereas the “Old route plan (after stop instruction position)” means routes that may change in future. Such a difference between the routes is displayed comprehensibly on the user interface screen. This provides an advantage that a user can distinguish the routes that the respective robots definitely pass through from the routes that may change in future.

For example, the display section 12 displays the user interface screen illustrated in FIG. 10 while the route planning section 11 is searching for routes. As illustrated in the example in FIG. 10, the user interface screen may display a sign 121 indicating that the replanning is being performed. In the example in FIG. 10, routes before stop instruction position are distinguished from routes after stop instruction position by using solid lines and broken lines. It is to be noted that the display mode is not limited to the example in FIG. 10, and a pattern in which the routes may be distinguished from each other by line thickness, a pattern in which the routes may be distinguished from each other by line color, or the like may be conceived. As the routes after the stop instruction positions, old routes are displayed before the route search finishes in the replanning, and after the route search finishes, the display is switched to new routes as illustrated in FIG. 11.

For example, after the new route plan is fixed, the display section 12 may display a sign 122 indicating that the replanning is completed on the user interface screen as illustrated in the example in FIG. 11. For example, as illustrated in the example in FIG. 11, the display section 12 deletes a route indicated by a dotted line during the replanning, and displays a new route found by the replanning as a fixed route by using a solid line.

### 1.3 Application Example

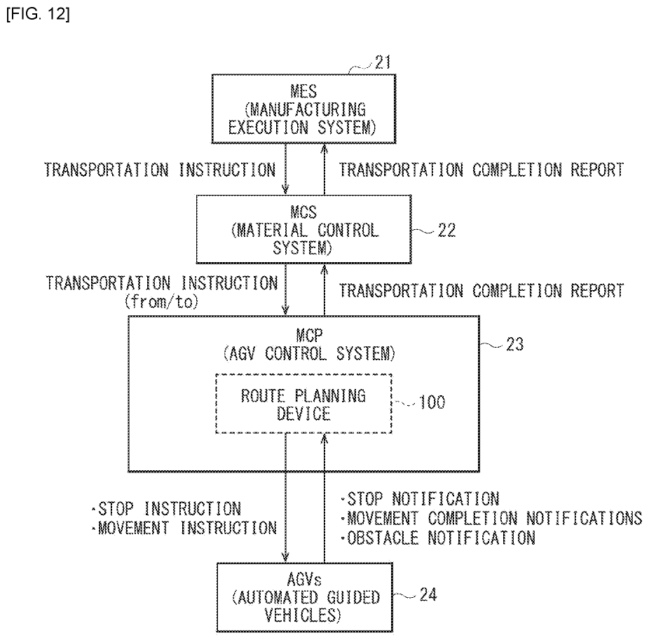

FIG. 12 schematically illustrates an example of a system to which the route planning device 100 according to the first embodiment is applied.

FIG. 12 illustrates an example of a system in which the route planning device 100 according to the first embodiment is applied to an automated transportation system in a factory that uses automated guided vehicles (hereinafter referred to as AGVs) 24. In this system, the AGVs 24 are the mobile bodies, and correspond to the robots 1 and 2 illustrated in FIG. 4. There are a plurality of the AGVs 24.

The automated transportation system includes a manufacturing execution system (MES) 21, a material control system (MCS) 22, an AGV control system (MCP) 23, and the AGVs 24.

The MES 21 issues a transportation instruction to the MCS 22 in accordance with a manufacturing process. Here, examples of the transportation instruction include an instruction to “transport C from a device A to a device B”, for example.

The MCS 22 decides which AGV24 is to be used for the transportation and how to transport C on the basis of the received transportation instruction, and further issues the transportation instruction to the MCP 23. For example, in the case where the plurality of AGVs 24 includes the AGV 24A, examples of the transportation instruction include an instruction to “an AGV 24A to transport C from a point A to a point B”.

When receiving the transportation instruction, the MCP 23 decides a specific movement route of the AGV 24. The MCP 23 includes the route planning device 100 according to the first embodiment illustrated in FIG. 4. When a new transportation instruction is issued from the MCS 22, it is possible for the AGV 24 to smoothly transition to a new route without stopping as much as possible even in the case where the route planning device 100 performs replanning according to the technology of the present disclosure and the route is changed by the global optimization algorithm.

### [1.4 Effects]

As described above, at the time of replanning, the route planning device 100 according to the first embodiment predicts future positions of robots and issues stop instructions to the respective robots on the basis of the predicted positions. The route planning device 100 searches for routes while the respective robots are moving. In the case where a solution is found before the respective robots stop, the route planning device 100 cancels the stop instructions and transitions to movement instructions based on a new route plan. At this time, the route planning device 100 determines timings of starting movement based on the new route plan in view of interference with an old route plan. This leads to effects listed below.
1. It becomes possible to improve movement efficiency (arrive at a goal point earlier) and consume less electric power by preventing the respective robots from stopping as much as possible when the plan is changed.
2. It is possible to prevent a collision or a deadlock due to change of plan.
3. The movement efficiency does not deteriorate so much even if frequency of replanning is increased. Therefore, it is possible to operate the system with a greater number of robots by using the global optimization algorithm, and it is also possible to operate the system in an environment including a lot of dynamic obstacles.

In addition, the route planning device 100 according to the first embodiment displays in the user interface at the time of replanning, a route before the stop instruction position being distinguishable from a route after the stop instruction position. This makes it possible for users to distinguish the routes that the respective robots definitely pass through from the routes that may change in future, in a situation where the routes change due to replanning.

It is to be noted that the effects described herein are only for illustrative purposes and is not limited, and there may be other effects. The same applies to effects according to other embodiments to be described below.

### 2. Other Embodiments

The technology according to the present disclosure is not limited to the above-described embodiment, and various kinds of modifications thereof can be made.

For example, the present technology may include the following configurations. The present technology having the following configurations predicts positions of a plurality of mobile bodies to be obtained after a lapse of a predetermined period of time, the plurality of mobile bodies moving in accordance with a first route plan, replans routes of the plurality of mobile bodies on the basis of a result of the prediction, and generates a second route plan during a period when at least one of the plurality of mobile bodies is moving in accordance with the first route plan. This makes it possible to efficiently replan routes of the plurality of mobile bodies.

(1)

A route planning device including:
a position prediction section that predicts positions of a plurality of mobile bodies to be obtained after a lapse of a predetermined period of time, the plurality of mobile bodies moving in accordance with a first route plan; and
a route planning section that replans routes of the plurality of mobile bodies on the basis of a result of a prediction made by the prediction section, generates a second route plan, and outputs movement instructions to the respective plurality of mobile bodies based on the second route plan, during a period when at least one of the plurality of mobile bodies is moving in accordance with the first route plan.
   (2)

The route planning device according to (1), further including
a stop position deciding section that decides stop instruction positions of the respective plurality of mobile bodies on the basis of the result of the prediction made by the prediction section, and outputs stop instructions to the respective plurality of mobile bodies.
   (3)

The route planning device according to (2), in which the stop position deciding section does not output the stop instruction to a mobile body that is not moving after the lapse of the predetermined period of time among the plurality of mobile bodies.

(4)

The route planning device according to (2) or (3), in which the route planning section searches for routes of the plurality of mobile bodies while the stop instruction positions are set as start points.

(5)

The route planning device according to (4), further including
a control section that cancels the stop instruction to a mobile body that has not arrived at the stop instruction position and then outputs the movement instruction based on the second route plan, in a case where the plurality of mobile bodies includes the mobile body that has not arrived at the stop instruction position when the route planning section finishes searching for the routes.
   (6)

The route planning device according to any one of (1) to (5), further including
a control section that outputs a movement instruction to a second mobile body in view of interference between a route of a first mobile body based on the first route plan and a route of the second mobile body based on the second route plan.
   (7)

The route planning device according to (6), in which, in a case where interference occurs between the route of the first mobile body based on the first route plan and the route of the second mobile body based on the second route plan, the control section outputs the movement instruction to the second mobile body based on the second route plan after the first mobile body finishes moving based on the first route plan.

(8)

The route planning device according to (6), in which, in a case where interference occurs between the route of the first mobile body based on the first route plan and the route of the second mobile body based on the second route plan, the control section temporarily stops movement of the second mobile body based on the second route plan before a position where the interference occurs, and restarts movement of the second mobile body after the first mobile body completes moving to the position where the interference occurs.

(9)

The route planning device according to (4) or (5), further including
a display section that displays a route of the first route plan in such a mode that a route before the stop instruction position is distinguishable from a route after the stop instruction position while the route planning section is searching for routes.
   (10)

The route planning device according to (9), in which, after the second route plan is fixed, the display section displays the stop instruction position and a route of the second route plan.

(11)

A route planning method including:
predicting positions of a plurality of mobile bodies to be obtained after a lapse of a predetermined period of time, the plurality of mobile bodies moving in accordance with a first route plan; and
replanning routes of the plurality of mobile bodies on the basis of a result of the predicting, generating a second route plan, and outputting movement instructions to the respective plurality of mobile bodies based on the second route plan, during a period when at least one of the plurality of mobile bodies is moving in accordance with the first route plan.
   (12)

A program that causes a computer to perform a process including:
predicting positions of a plurality of mobile bodies to be obtained after a lapse of a predetermined period of time, the plurality of mobile bodies moving in accordance with a first route plan; and
replanning routes of the plurality of mobile bodies on the basis of a result of the predicting, generating a second route plan, and outputting movement instructions to the respective plurality of mobile bodies based on the second route plan, during a period when at least one of the plurality of mobile bodies is moving in accordance with the first route plan.

The present application claims the benefit of Japanese Priority Patent Application JP2021-64450 filed with the Japan Patent Office on Apr. 5, 2021, the entire contents of which are incorporated herein by reference.

It should be understood by those skilled in the art that various modifications, combinations, sub-combinations and alternations may occur depending on design requirements and other factors insofar as they are within the scope of the appended claims or the equivalents thereof.

1. A route planning device comprising:
a position prediction section that predicts positions of a plurality of mobile bodies to be obtained after a lapse of a predetermined period of time, the plurality of mobile bodies moving in accordance with a first route plan; and
a route planning section that replans routes of the plurality of mobile bodies on a basis of a result of a prediction made by the prediction section, generates a second route plan, and outputs movement instructions to the respective plurality of mobile bodies based on the second route plan, during a period when at least one of the plurality of mobile bodies is moving in accordance with the first route plan.

2. The route planning device according to claim 1, further comprising a stop position deciding section that decides stop instruction positions of the respective plurality of mobile bodies on the basis of the result of the prediction made by the prediction section, and outputs stop instructions to the respective plurality of mobile bodies.

3. The route planning device according to claim 2, wherein the stop position deciding section does not output the stop instruction to a mobile body that is not moving after the lapse of the predetermined period of time among the plurality of mobile bodies.

4. The route planning device according to claim 2, wherein the route planning section searches for routes of the plurality of mobile bodies while the stop instruction positions are set as start points.

5. The route planning device according to claim 4, further comprising a control section that cancels the stop instruction to a mobile body that has not arrived at the stop instruction position and then outputs the movement instruction based on the second route plan, in a case where the plurality of mobile bodies includes the mobile body that has not arrived at the stop instruction position when the route planning section finishes searching for the routes.

6. The route planning device according to claim 1, further comprising a control section that outputs a movement instruction to a second mobile body in view of interference between a route of a first mobile body based on the first route plan and a route of the second mobile body based on the second route plan.

7. The route planning device according to claim 6, wherein, in a case where interference occurs between the route of the first mobile body based on the first route plan and the route of the second mobile body based on the second route plan, the control section outputs the movement instruction to the second mobile body based on the second route plan after the first mobile body finishes moving based on the first route plan.

8. The route planning device according to claim 6, wherein, in a case where interference occurs between the route of the first mobile body based on the first route plan and the route of the second mobile body based on the second route plan, the control section temporarily stops movement of the second mobile body based on the second route plan before a position where the interference occurs, and restarts movement of the second mobile body after the first mobile body completes moving to the position where the interference occurs.

9. The route planning device according to claim 4, further comprising a display section that displays a route of the first route plan in such a mode that a route before the stop instruction position is distinguishable from a route after the stop instruction position while the route planning section is searching for routes.

10. The route planning device according to claim 9, wherein, after the second route plan is fixed, the display section displays the stop instruction position and a route of the second route plan.

11. A route planning method comprising:
predicting positions of a plurality of mobile bodies to be obtained after a lapse of a predetermined period of time, the plurality of mobile bodies moving in accordance with a first route plan; and
replanning routes of the plurality of mobile bodies on a basis of a result of the predicting, generating a second route plan, and outputting movement instructions to the respective plurality of mobile bodies based on the second route plan, during a period when at least one of the plurality of mobile bodies is moving in accordance with the first route plan.

12. A program that causes a computer to execute a process, the process comprising:
predicting positions of a plurality of mobile bodies to be obtained after a lapse of a predetermined period of time, the plurality of mobile bodies moving in accordance with a first route plan; and
replanning routes of the plurality of mobile bodies on a basis of a result of the predicting, generating a second route plan, and outputting movement instructions to the respective plurality of mobile bodies based on the second route plan, during a period when at least one of the plurality of mobile bodies is moving in accordance with the first route plan.
